(19) United States
(12) Patent Application Publication
(10) Pub. No.: US 2021/0021139 A1
(43) Pub. Date: Jan. 21, 2021

(54) MULTI-VOLTAGE PORTABLE POWER SYSTEM

(71) Applicant: Michael E. Windsor, Pittsburg, KS (US)

(72) Inventor: Michael E. Windsor, Pittsburg, KS (US)

(21) Appl. No.: 16/933,508

(22) Filed: Jul. 20, 2020

Related U.S. Application Data
(60) Provisional application No. 62/876,061, filed on Jul. 19, 2019.

(51) Int. Cl. H02J 7/00; H02J 1/10; H02J 7/34; B60K 1/04

(52) U.S. Cl. CPC H02J 7/0024; H02J 1/122; H02J 7/342; B60K 2001/0416; B60K 1/04; H02J 7/0044; H02J 7/0019

(57) ABSTRACT

A multi-voltage portable power system includes a plurality of batteries or energy storage devices connected to one or more conversion switches. The conversion switches are actuated in response to an operator-controlled control switch, remotely operated device, or microprocessor controller command. The conversion switches interconnect the batteries of the system to provide a desired output voltage to an output connector, that is then connected to a load. The power output at the desired voltage may be used by a user to jump start vehicles and industrial engines, power equipment, power welding devices, provide battery backup for telecommunication switching systems, provide charge power for an energy storage device or battery assembly, power military applications requiring various levels of power, or for any other desired usage. The system is configured to be contained in various transportable housings.

### CROSS-REFERENCE TO RELATED APPLICATIONS

This application claims the benefit of U.S. Provisional Patent Application No. 62/876,061, filed Jul. 19, 2019, the disclosure of which is hereby incorporated herein in its entirety by reference.

### BACKGROUND

Portable power systems, such as portable jump starters for vehicles, or portable power and utility systems used to provide power in remote areas, are known in the art. For example, consumer jump starter products which include an internal battery or energy storage device, with external jumper cables and clamps for attachment to the battery terminals of a standard vehicle's direct current (DC) electrical system are readily available at retailers throughout the U.S. and world. More complex systems which incorporate a DC power supply system with additional auxiliary equipment, such as a pneumatic air compressor, hydraulic system, and/or an electrical power inverter (for supplying Alternating Current (AC) power), are also known.

Such complex systems are often integrated into enclosures for portable self-contained use or these systems can be configured for mounting in or on, various host vehicles, for use in remote locations where there is no utility power available. One such system is the Portable Power and Utility System of U.S. Pat. No. 8,013,567, which is hereby incorporated by reference in its entirety. The '567 Patent describes a system including a DC battery power subsystem, and/or an AC electric power subsystem, and/or a fluid power subsystem (i.e.: air, hydraulic oil, gas) housed in an enclosure, for completely portable and separately transportable operation. The system primarily provides: portable AC electric power for operating pluggable AC electric hand tools, charging battery packs for hand held tools, operating AC welders, and other AC electric backup power needs; fluid power (i.e.: compressed air) for airing up tires, operating air jacks, air impact wrenches, air powered nail guns; and high powered DC electrical voltage and current for jump starting vehicles and equipment as needed by the user, as well as providing high-powered DC electrical power for heavy duty welding applications in the field. The portable power and utility system of the '567 Patent can be attached to a host vehicle, solar panel(s), wind turbine, or other energy producing device for the recharging of the internal battery systems (or energy storage devices) in the field.

While such systems are useful and desirable for their intended purpose, they are not intended or configured to work with vehicles or electrical systems having differing voltage electrical systems. For instance, most consumer vehicles operate on a twelve-volt (12V) DC electrical system, while many larger vehicles such as excavation equipment, and military vehicles typically use a twenty-four volt (24V) DC electrical system. Beyond this, there are many other industrial equipment engines and vehicles that operate at twenty four (24V), thirty six (36v), forty eight (48), or sixty volts (60) DC, with some vehicles such as personal scooters and freight train locomotives using a seventy two volt (72V) DC system. Modern electric automobiles are using systems in the three-hundred-seventy-five (375V) volt range for best performance. The industry is generally heading towards even higher voltage systems in larger industrial equipment and vehicles, including large engine driven backup power generation systems used during emergencies. Thus, to jump start the engine of each vehicle or piece of industrial equipment or to charge or operate a high DC voltage load, the portable power electrical system must be able to match the DC voltage of the engine system to properly attempt to jump start the engine of the vehicle in question or the portable power system must match the DC voltage required by the load, or the load requirement of the equipment to be powered or charged. For example, to properly charge a seventy two (72v) volt DC electric powered personal scooter, you must be able to match the DC voltage of the scooter's electrical system (the load) with the appropriate DC charge voltage output from the portable power system, which may be attached to a host vehicle with an operational DC electrical system of only twelve (12V) volts. Thus, the portable power system must be able to alter its operating voltage from a twelve (12V) volt DC system, which allows the host vehicle's electrical system to recharge the portable power system when the host vehicle's engine is operating, and then alter its power output to seventy two (72) volts DC when needed to provide electrical charge power or operating power to the scooter. Once the task has been completed, the portable power system can then be altered or configured back to its normal operating voltage, characteristic of its host vehicle's electrical operating system.

In view of the various voltage systems available and in use today, it can be seen that conventional single-voltage auxiliary power systems are inadequate to accommodate that variation in voltage requirements. A twelve (12V) volt consumer jump-starter product is of no use to a vehicle requiring twenty-four (24V), thirty six (36V), or even higher voltages. In order to accommodate vehicles or equipment having varying voltage electrical systems, the current state of the art requires one to have several different auxiliary systems, with each auxiliary system specifically configured to work with an electrical system of a particular voltage. For example, a construction worker attempting to jump start a large construction vehicle in the field, such as a track hoe excavator which is normally found to be a twenty four (24V) volt system, must use a portable power system that matches the particular higher voltage system of that specific vehicle in order to attempt a proper jump start. Because the construction worker's typical vehicle is a common pickup style truck, operating on a (12V) twelve-volt DC electrical system, the truck vehicle cannot be used to attempt a proper jump start on a particular piece of heavy equipment which operates on a twenty four (24V) volt (or higher) DC electrical system. Thus, the worker is then forced to locate and use another large construction vehicle (assuming one is available) that has a matching voltage DC electrical system to the vehicle being jump started, and that vehicle must be driven or transported to the problem vehicle location and positioned accordingly so that jumper cables can be properly attached between the two pieces of equipment and a jump start attempted. If no other matching DC electrical system vehicle is available, then new batteries must be purchased and installed in the problem vehicle, or a specific matching DC electrical jump starting system must be located or purchased to attempt the jump start, adding additional cost, labor, and time, to the end user.

The mechanical enclosures in which these limited voltage systems are supplied, are packaged in a manner to accommodate the function of the unit only, which in most cases is not necessarily accommodating to the user. Heavier equipment and larger engines require much larger power systems which are heavy, cumbersome, and typically take up bed space or storage area of a vehicle, which is not convenient to the user/operator. Most of the existing systems require fuel, such as gasoline or diesel for operation, which is also typically carried in separate fuel containers, thus taking up even more bed space/storage area, and in some cases laws require the operator to place placards on their vehicle for the transport of hazardous or flammable chemicals, increasing their insurance liability and increasing the potential for a dangerous fire if the vehicle is involved in an accident.

Thus, it can be seen that there remains a need in the art for an improved multi-voltage portable power system that is also mechanically practical and accommodating to the user in various configurations.

### SUMMARY

Embodiments of the invention are defined by the claims below, not this summary. A high-level overview of various aspects of the invention is provided here to introduce a selection of concepts that are further described in the Detailed Description section as follows. This summary is not intended to identify key features or essential features of the claimed subject matter, nor is it intended to be used in isolation to determine the scope of the claimed subject matter. In brief, this disclosure describes, among other things, numerous embodiments of a multi-voltage portable power system.

In one aspect, the multi-voltage portable power system of the present invention provides a portable or transportable power supply system capable of being switched between one of a plurality of output voltages for use with various vehicles, farm equipment, industrial equipment, commercial equipment, aquatic equipment, military equipment, aircraft equipment, and other vehicles and/or equipment having an electrical system which requires power to jump start, or to charge, or to operate them properly.

In an exemplary embodiment, the multi-voltage portable power system includes a plurality of batteries or energy storage devices connected to one or more conversion switches. The conversion switches are actuated in response to an operator-controlled control switch or remotely operated device, or in response to a command signal from a microprocessor controller, the conversion switches interconnect the batteries of the system to provide a desired output voltage to an output connector, that is then connected to a load. This power output at the desired voltage may be used by a user to jump start vehicles and industrial engines, power equipment, power welding devices, provide battery backup for telecommunication switching systems, provide charge power for an energy storage device or battery assembly, power military applications requiring various levels of power, or for any other desired usage.

In the first described embodiment, the multi-voltage portable power system is deployed in a crossover truck toolbox style enclosure, or in a chest toolbox style enclosure, with or without storage, designed for attachment on or in a vehicle. A vehicle connection cable assembly that electrically interlinks the multi-voltage portable power system to the host vehicle is used to recharge the system batteries and communicate with the host vehicle.

In a secondary embodiment, the multi-voltage power system is deployed in a totally portable, one-man transportable enclosure for use external to, and independently of, a vehicle, while still having the capability in some cases to be easily attachable to the vehicle for transport or continued use, while offering additional support and functions to the operator. The enclosure can be configured with handles and wheels for ease of movement and transport by the operator.

In a third described embodiment, the multi-voltage portable power system is deployed in what shall be called a ‘power pod module’ that can be configured for mounting singularly in or on a vehicle, in a vertical or horizontal mode, with or without storage space for additional components and accessories. When mounted in the horizontal mode, the chassis of the power pod module is made structurally sound to support a significant amount of weight for load bearing during its normal use.

### DESCRIPTION OF THE DRAWINGS

Illustrative embodiments of the invention are described in detail below with reference to the attached drawing figures, and wherein:

FIG. 1 is a schematic diagram of a multi-voltage portable power system in accordance with a first exemplary embodiment of the present invention.

FIG. 2 is a schematic diagram of a multi-voltage portable power system in accordance with a second exemplary embodiment of the present invention.

FIG. 3 is a close-up view of a first portion of the schematic diagram of FIG. 2.

FIG. 4 is a close-up view of a second portion of the schematic diagram of FIG. 2.

FIG. 5 is a perspective view of a multi-voltage portable power system in a transportable enclosure in accordance with an exemplary embodiment of the present invention.

FIG. 6 is a view of a voltage selection switch of the multi-voltage portable power system of FIG. 5.

FIG. 7 is a perspective view of a multi-voltage portable power system in a portable enclosure in accordance with a fourth exemplary embodiment of the present invention.

FIG. 8 is a perspective view of a multi-voltage portable power system in a portable enclosure in accordance with a fifth exemplary embodiment of the present invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

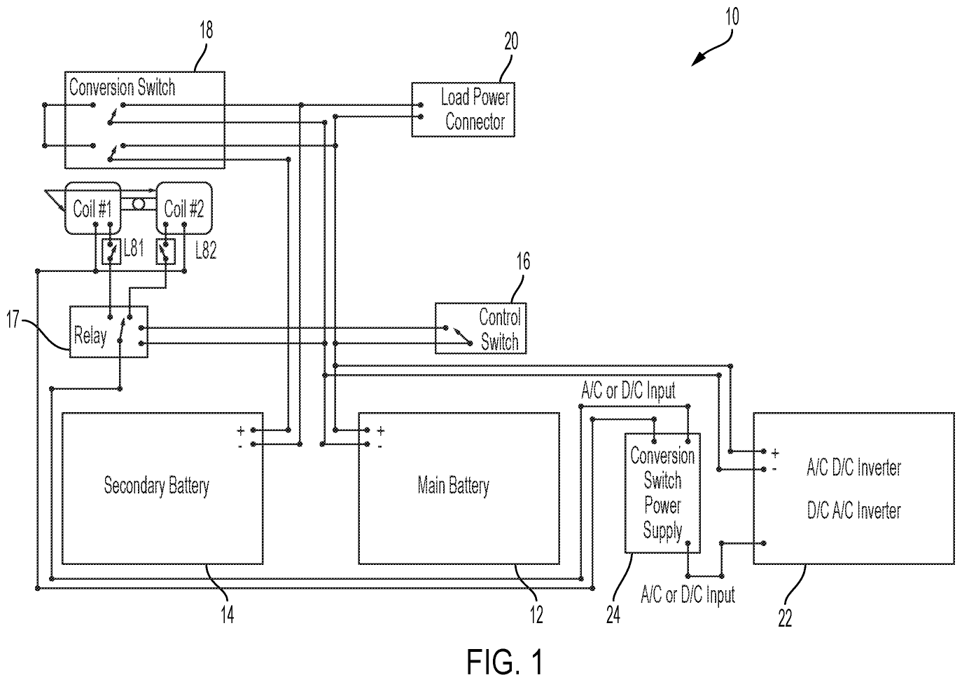

Looking first to FIG. 1, a multi-voltage portable power system in accordance with a first exemplary embodiment of the present invention is depicted generally by the numeral 10. In this example, the multi-voltage portable power system 10 generally comprises an internal main battery 12 and additional internal battery systems 14 as required by the application, a control switch 16, a conversion switch 18, and a load power connector 20, interconnecting the additional battery systems 14, to the main battery 12 which are thus connected together in accordance with the configuration required by the application/operator, of series or parallel circuitry, providing the necessary output or load voltage output required by the application or by an operator of the multi-voltage portable power system 10 to provide power to external equipment, jump start external vehicles, and the like.

Conversion switch 18 provides power to the load power connector 20 from the main and secondary batteries 12, 14. The position of control switch 16, which controls relay 17, determines whether the conversion switch 18 connects the main and secondary batteries in series or in parallel to provide the desired output voltage. Thus, for example, using standard twelve-volt batteries, the output voltage at the load power connector 20 may be switched between twelve volts (with the main and secondary batteries connected in parallel to provide the twelve volts) or twenty-four volts (with the main and secondary batteries connected in series circuit pattern to provide the twenty-four volts). The system thus enables a portable power system, having a nominal operating voltage of twelve volts, to provide twenty-four volts to the load power connector 20 as desired by a user activating the control switch 16, either manually or electronically.

In an exemplary embodiment, a multi-voltage portable power system in accordance with the present invention, having two twelve-volt batteries, may be used to provide either twelve (12V) volt or twenty four (24V) volt power to the load power connector 20. The portable power system may thus be used in a vehicle having a twelve (12V) volt system to provide nominal twelve (12V) volts to the load power connector to allow, for example, jump starting another vehicle having a twelve (12V) volt system or used to self-jump start the host vehicle. In addition, that same portable power system may be used to provide twenty four (24V) volts to, for example, jump start a vehicle having a twenty four (24V) volt system or power a DC voltage welding device which can be used in a totally portable configuration.

Main and secondary batteries 12, 14 may be any type of energy storage and discharge component known in the art, such as batteries, including lead-acid batteries, absorbent glass matt (AGM) batteries, lithium batteries, or nickel cadmium (NiCad) batteries, nickel zinc, or other energy storage devices, such as capacitors, super capacitors, and the like.

Looking still to FIG. 1, the main battery 12 further provides power to inverter circuitry 22 that converts the DC voltage provided by the main battery 12 to an AC voltage. In one embodiment, the inverter circuitry provides 120 volts AC for internal and/or external use in the multi-voltage portable power system 10. For example, the 120 volts AC may be used to provide power to an outlet plug to provide standard AC electric power to a user for their electric power needs such as for charging battery pack hand power tools, regular AC powered tools, operating an appliance, or other AC electric powered system, or the AC electric power may be used to power auxiliary equipment within the portable power system, such as air compressors, radios, lights, and the like. As seen in the exemplary embodiment of FIG. 1, the AC power is used to provide actuating power to the conversion switch 18 via a conversion switch power supply 24. The conversion switch power supply may need to be operated at even a higher AC voltage, like 220V AC. Where necessary, step-up transformers, or AC to AC conversion circuitry is utilized to supply the AC power needed to achieve the necessary conversion switch(s) operation(s). In alternative embodiments, the inverter circuitry provides DC to AC, or AC to DC, or DC to DC conversion(s) to provide various AC & DC, level voltages to power the auxiliary equipment within the portable power system enabling it to perform its proper function.

In operation of the multi-voltage portable power system, the main battery 12, secondary battery 14, and any additional main or secondary batteries 12, 14 are preferably charged and ready to provide power as demanded by a user. It should be understood that a charge to the batteries may be provided by an electrical system of a vehicle, such as an alternator system on the vehicle, or may be provided by an external AC or DC power supply connected to the multi-voltage portable power system such that the batteries are charged prior to deployment of the system or while the system is in operation. In one embodiment, the inverter circuitry 22 may include conversion and charging circuitry to accomplish charging of the main 12 and secondary 14 batteries. Preferably, the main 12 and secondary 14 batteries are charged simultaneously, in alternative embodiments the batteries may be selectively charged via control circuitry or via user selection.

With the batteries 12, 14 charged and the control switch 16 in its normally open position, relay 17 is not activated and thus no power is applied to the coils of the conversion switch 18. In that case, as seen in the schematic diagram of FIG. 1, the main 12 and secondary 14 batteries are connected in parallel via the conversion switch 18 such that twelve volts is provided to the load power connector 20. Upon activation of the control switch 16 by the operator, the control switch 16 is closed, providing power to relay 17 which in turn provides power from the conversion switch power supply 24 to the coils of the conversion switch 18. With the conversion switch thus activated, the main battery 12 and secondary battery 14 are configured in series through the conversion switch 18 and twenty four (24V) volts is provided to the load power connector 20. As can be seen, an operator can thus selectively provide either twelve (12V) or twenty four (24v) volts to the load power connector simply by operating the single control switch 16. It should be noted that other embodiments of this configuration can be scaled up or down to meet the demand requirements of the user for more or less power in voltage and amperage to meet the load requirements and the switching configuration can be controlled with the operation of a single switch or with additional switches that will change the actual output of voltage and amperage to meet the user's demand. This configurational change can also be achieved with the use of microprocessor-controlled devices, and/or wireless remote control or smart phone interlink and other various communication devices. Switching configurations can be made by manual, electronic, electromechanical servos, solid state, or other controllable means. Feedback sensors and monitoring devices with indicators or smart phone interfaces may be used to verify switching positions, voltage outputs, and other readings of the device's status to ensure proper outputs and user safety.

Conversion switch 18 may be any type of switching mechanism, or combination of switching mechanisms, known in the art, preferably configured to accommodate high currents and voltage levels. For example, the conversion switch may be a mechanical contactor, a solenoid, a mechanical or solid-state relay, a transfer switch or other such device as known in the art. Furthermore, actuation of the conversion switch 18 may be accomplished electrically via AC or DC power through a switch, pneumatically, manually, hydraulically, or via any other actuation means known in the art. Most preferably, the conversion switch 18 provides isolation of the load power connector 20 (or other circuitry to which it is connected) during the switching operation.

The load power connector 20 may be any type of connector adapted to attach to cables or equipment as desired by the user or operator of the portable and/or fixed load system. For example, the load power connector may be an Anderson style heavy duty quick disconnect connector, CATPLUG connector, NATO Military Vehicle Slave connector, or any other type of connector known in the art that can transfer, in most cases, high power electricity.

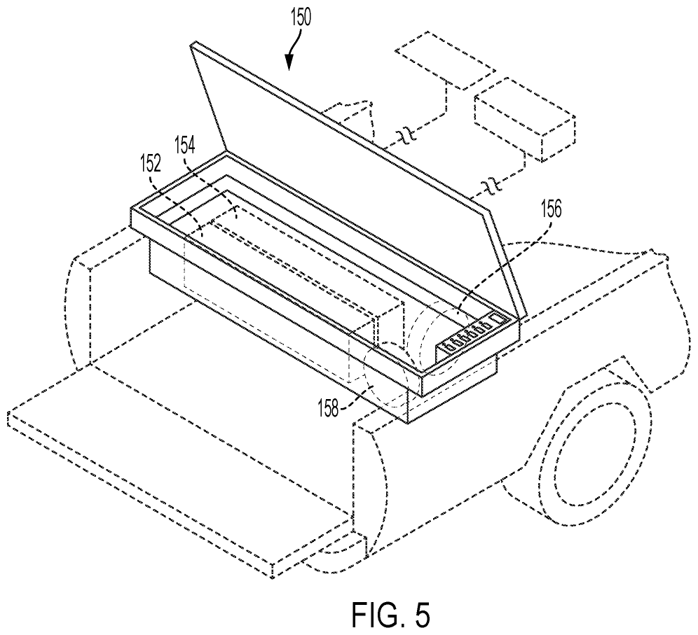

Turning to FIG. 5, an exemplary embodiment of a multi-voltage portable power system as just described in accordance with the present invention embodied in an enclosure for mounting in a truck vehicle is depicted generally as numeral 150. The enclosure, which may alternatively include additional storage to act as a toolbox, in this example, houses the main and secondary batteries 152, 154, as well as auxiliary equipment 156, 158 with control switches and circuitry 120 mounted along a side panel of the enclosure. In this embodiment, the multi-voltage portable power system is configured in a transportable enclosure (crossover truck toolbox) mounted in a host vehicle in accordance with an exemplary embodiment of the present invention.

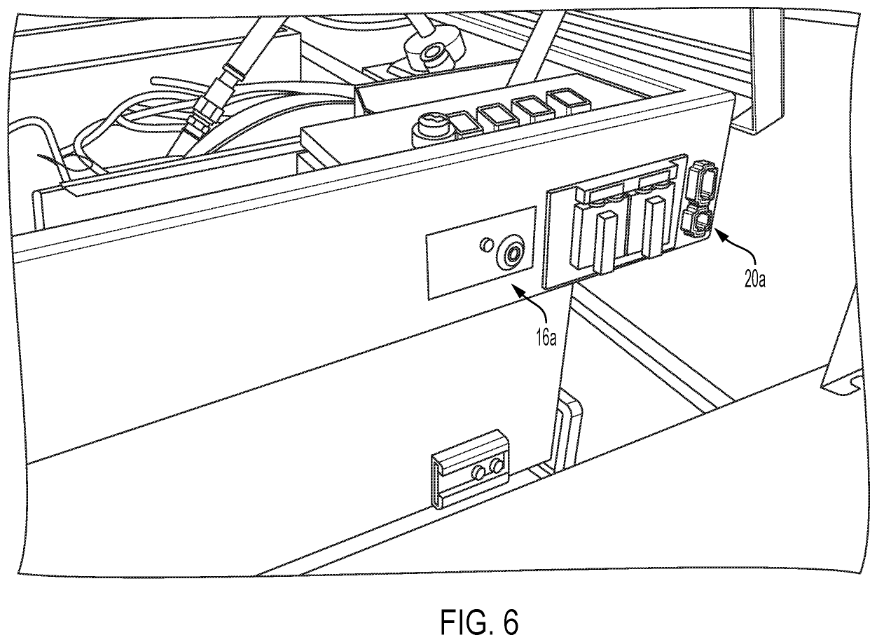

Looking to FIG. 6, an exemplary embodiment of the multi-voltage portable power system includes a control switch 16a actuable by a user to select the output voltage at the load power connector 20a. In the exemplary embodiment, the control switch 16a is a key switch. In alternative embodiments, the control switch may be any type of switch or switching mechanism known in the art, including, but not limited to, toggle switches, rocker switches, pushbutton switches digital switches, relays programmable logic controllers (PLCs), remote control switches, or any other switching or actuating device, mechanically activated or activated by remote control.

It should be understood that while the exemplary embodiment as described above is a nominal twelve (12V) volt system that is switchable to twenty four (24V) volts, that other nominal voltage and switchable configurations are encompassed by the present invention. For example, the main and secondary batteries may each be six (6V) volts, such that the system provides a nominal six (6V) volts that is switchable to twelve (12V) volts, or that other combinations of nominal and switchable voltage levels, such as twenty four (24V) volts nominal, switchable to forty eight (48) volts, or other combinations as required by a user of the multi-voltage portable power system.

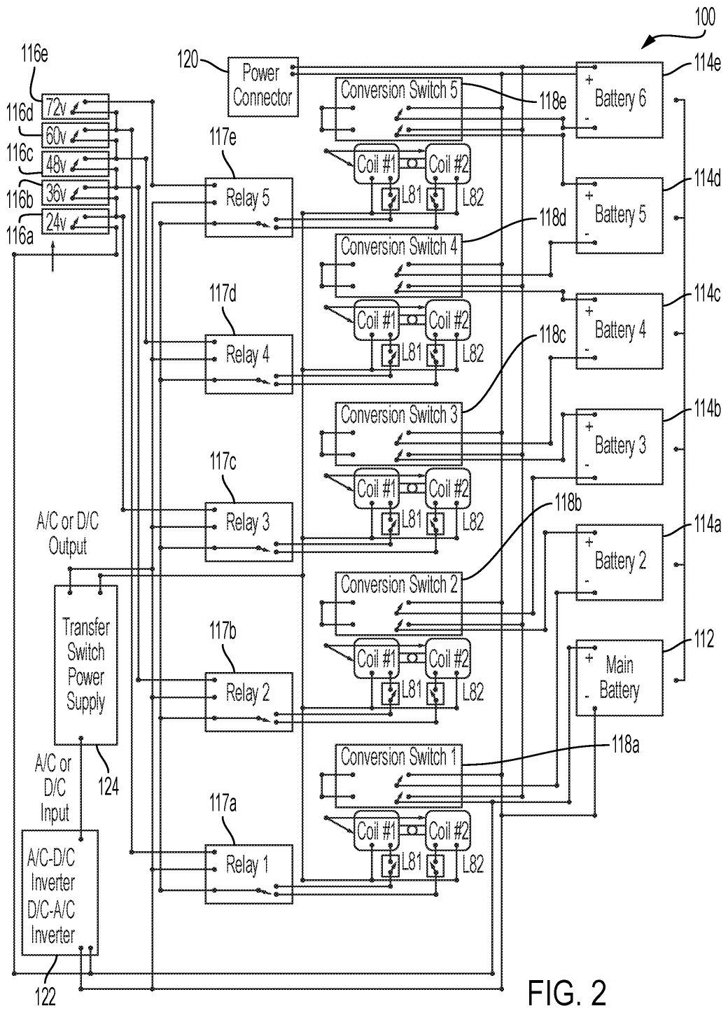

It should be further understood that the multi-voltage portable power system of the present invention may employ additional batteries and conversion switch circuitry to accomplish higher voltage levels, and to provide multiple voltage outputs, as will now be described with respect to FIGS. 2 through 4.

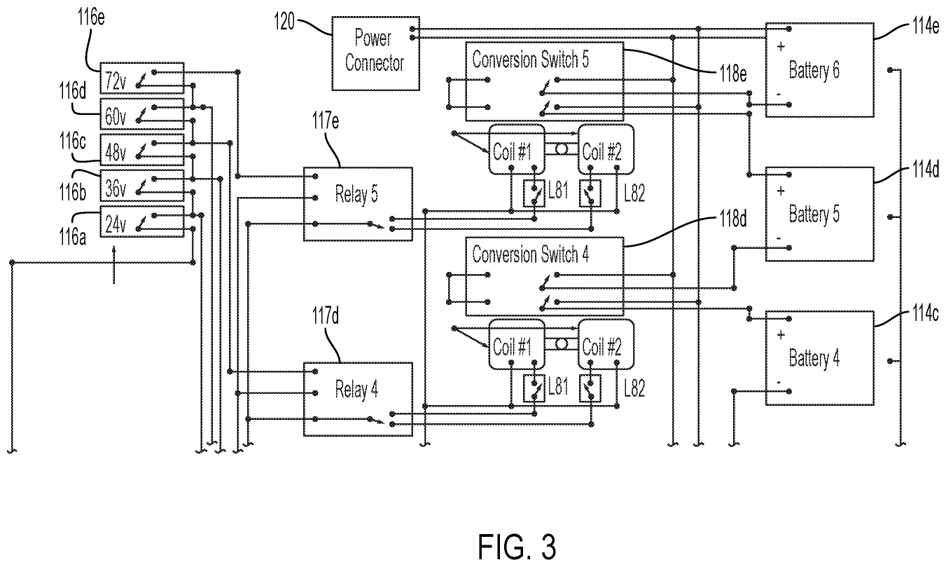

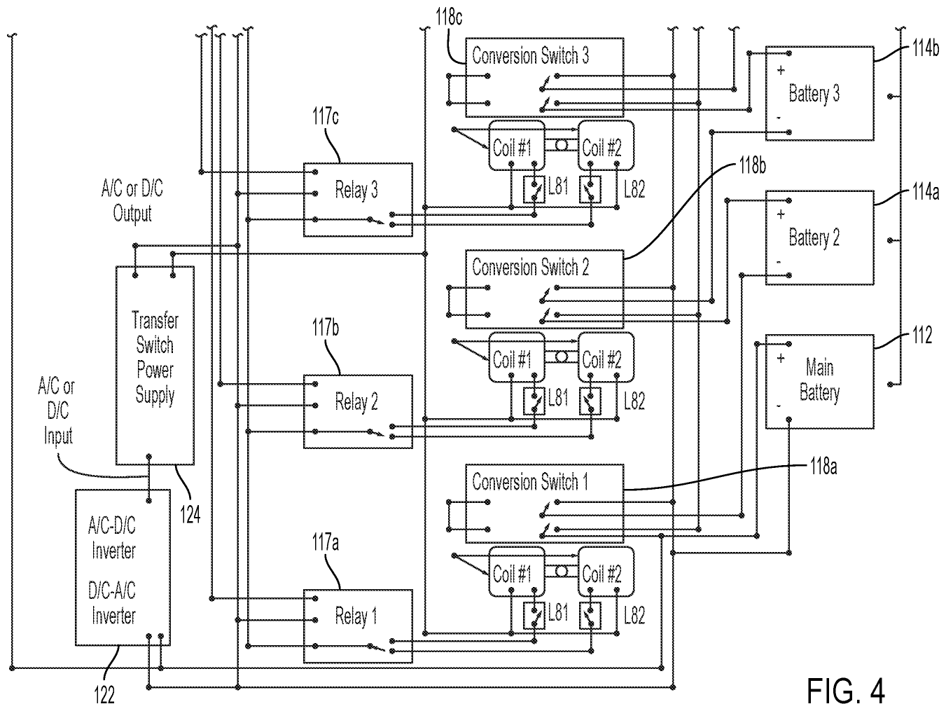

Turning to FIGS. 2 through 4 (with FIGS. 3 and 4 providing a close-up view of the schematic of FIG. 2), a multi-voltage portable power system in accordance with an exemplary embodiment of the present invention is depicted generally by the numeral 100.

Similar to the exemplary embodiment of the multi-voltage portable power system 10 described above, the multi-voltage portable power system 100 includes main battery 112 with a plurality of auxiliary batteries 114a, 114b, 114c, 114d, and 114e; a plurality of control switches 116a, 116b, 116c, 116d, and 116e; a plurality of conversion switches 118a, 118b, 118c, 118d, and 118e, and a load power connector 120.

The main 112 and auxiliary batteries 114a, 114b, 114c, 114d, and 114e, in accordance with the configuration of the control switches 116a, 116b, 116c, 116d, and 116e, provide power at a desired voltage level to load power connector 120 for use by an operator of the multi-voltage portable power system 100 to provide power at a desired voltage level to external equipment, jump start external vehicles, and the like.

Conversion switches 118a, 118b, 118c, 118d, and 118e direct power to the load power connector 120 from the main 112 and auxiliary 114a, 114b, 114c, 114d, and 114e batteries. The position of the control switches 116a, 116b, 116c, 116d, and 116e—each of which controls a corresponding relay 117a, 117b, 117c, 117d, and 117e—determines the switching configuration of the corresponding conversion switches 118a, 118b, 118c, 118d, and 118e, which connect the main and auxiliary batteries in series or in parallel to provide the desired output voltage(s). Thus, for example, using standard twelve (12V) volt batteries, the output voltage at the load power connector 120 may be switched between twelve (12V) volts, twenty four (24V) volts, thirty six (36V) volts, forty eight (48V) volts, sixty (60V) volts, and seventy two (72V) volts, with the main and auxiliary battery systems connected in series, parallel, or combinations thereof to attain the desired output voltage.

The system thus enables the portable power system, having a nominal operating voltage of twelve (12V) volts, to provide any of the desired voltages (twelve (12V) volts, twenty four (24V) volts, thirty six (36V) volts, forty eight (48V) volts, sixty (60V) volts, or seventy two (72V) volts) to the load power connector 120 as desired by a user activating the appropriate one of the control switches 116a, 116b, 116c, 116d, or 116e. Thus, the multi-voltage portable power system may be used to provide power to convention consumer vehicles, large commercial truck equipment, agricultural equipment, tractors, construction dozing, excavating and other industrial equipment, military equipment, cranes, locomotives, mining equipment, aircraft equipment, engines for backup generators for; telecommunications, hospitals, portable generators (military, commercial, or private), backup engines for pumps; irrigation, waterway drainage, sewage, potable water, oil/petroleum, and virtually any other equipment (portable or stationary) or vehicle having an electrical system.

The main and auxiliary batteries 112, 114a, 114b, 114c, 114d, 114e may be any type of energy storage and discharge component known in the art, such as batteries, including lead-acid batteries, absorbent glass matt (AGM) batteries, lithium batteries, or nickel cadmium (NiCad), nickel zinc batteries, or other energy storage devices, such as capacitors, super capacitors, and the like.

Looking still to FIGS. 2 thorough 4, the main battery 112 further provides power to inverter circuitry 122 that converts the DC voltage provided by the main battery 112 to an AC voltage. In one embodiment, the inverter circuitry provides one hundred twenty (120V) volts AC for internal and/or external use in the portable power system 110. For example, the one hundred twenty (120V) volts AC may be used to provide power to an outlet plug to provide standard AC power to a user's power tools, etc., or may be used to power auxiliary equipment within the portable power system itself, such as air compressors, sensor and control circuitry, radios, lights, and the like. In the exemplary embodiment of FIGS. 2 through 4, the AC power is used to provide actuating power to the conversion switches 118a, 118b, 118c, 118d, and 118e via a conversion switch power supply 124. In alternative embodiments, the inverter circuitry provides DC to DC conversion to provide various DC level voltages to power auxiliary equipment within the multi-voltage portable power system. In alternative embodiments the AC power produced may be matched to electrical world-use standards as required by the location of the work being done. For example, European standards would be 220V AC at 50 HZ, or other standards as set forth by the country of use, including variations in DC standards.

In operation of the multi-voltage portable power system, the main battery and auxiliary batteries are preferably charged and ready to provide power as demanded by a user. It should be understood that a charge to the batteries may be provided by an electrical system of a vehicle, such as an alternator system on the vehicle, or may be provided by an external AC or DC power supply connected to the multi-voltage portable power system such that the batteries are charged prior to deployment of the system or during actual operation. In one embodiment, the inverter circuitry 122 may include conversion and charging circuitry to accomplish charging of the main 112 and auxiliary 114a, 114b, 114c, 114d, 114e batteries. Preferably, the main and auxiliary batteries are charged simultaneously, although in alternative embodiments the batteries may be selectively charged via control circuitry or via user selection. Auxiliary switches or control circuitry may be included in the design to connect or disconnect batteries individually via user selection, or connect or disconnect the load power connector 120.

With the batteries and the control switches 116a, 116b, 116c, 116d, 116e in their normally open positions, relays 117a, 117b, 117c, 117d, 117e are not activated and thus no power is applied to the coils of the conversion switches 118a, 118b, 118c, 118d, 118e. In that case, as seen in FIGS. 2 through 4, the main and auxiliary batteries are connected in parallel via the conversion switches default positions such that twelve (12V) volts (comprised of the plurality of batteries wired/configured in parallel mode) is provided to the load power connector 120. Upon activation of one of the control switches 116a, 116b, 116c, 116d, 116e by the operator, the activated switch provides power to the corresponding relay 117a, 117b, 117c, 117d, 117e which in turn provides power from the conversion switch power supply 124 to the coils of the corresponding conversion switch. With the conversion switch thus activated, the main and auxiliary batteries are configured in series and/or parallel combinations through the conversion switches and the appropriate voltage is provided to the load power connector 120. As can be seen, an operator can thus selectively provide any of the desired voltages (twelve, twenty-four, thirty-six, forty-eight, sixty, seventy-two and other variations) to the load power connector simply by operating a single control switch or actuation device.

The conversion switches may be any type of switching mechanism, or combination of switching mechanisms, known in the art, preferably configured to accommodate high currents and voltage levels. For example, the conversion switch may be a contactor, a solenoid, a mechanical or solid-state relay, a transfer switch or other such device as known in the art. Contactors, solenoids, and other transfer switch devices can be latching or non-latching, or configured to be maintained throughout any operation. Furthermore, actuation of the conversion switch 18 may be accomplished electrically via AC or DC power through a switch, pneumatically, manually, hydraulically, or via any other actuation means known in the art. Most preferably, the conversion switches provide isolation of the load power connector 120 (or other circuitry to which it is connected) during the switching operation. Conversion switches and their electronic control circuitry may be specialized for applications within explosive gaseous environments and other applications for extreme and hazardous environments, including electromagnetic pulse applications.

The load power connector 120 may be any type of connector adapted to attach to cables or equipment as desired by the user or operator of the multi-voltage portable power system. For example, the load power connector may be an Anderson brand (or similar) quick disconnect style of connector, CATPLUG style connector, NATO slave connector, or any other type of connector known in the art.

Control switches 116a, 116b, 116c, 116d, 116e may be any type of switch or switching mechanism known in the art, including, but not limited to, toggle switches, rocker switches, pushbutton switches, digital switches, relays, programmable logic controllers (PLCs), remote control switches, or any other switching or actuating device. Preferably, the control switches comprise a key, cover, interlock, or safety device to prevent unintentional operation. Most preferably, the plurality of control switches may include an interlock mechanism to prevent activation of multiple switches simultaneously or the system may be configured to switch several mechanisms at the same time for the desired output result. In one embodiment, a microprocessor or computer-controlled device activates and operates the system to the operator's desired settings.

As described previously, FIGS. 5 and 6 depict an exemplary embodiment of the multi-voltage portable power system of the present invention deployed in a toolbox style enclosure for use in or on a vehicle.

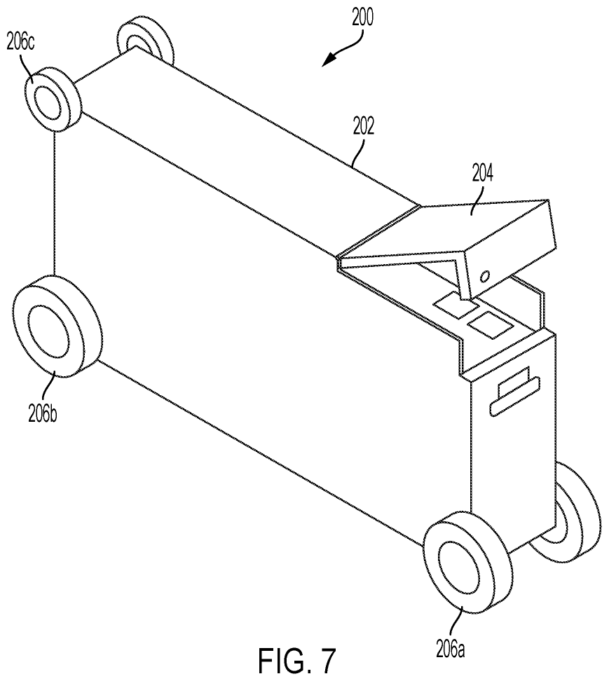

Turning to FIG. 7, in another exemplary embodiment denoted generally by the numeral 200, the multi-voltage portable power system of the present invention is deployed in a fully portable and transportable enclosure that may have handles, wheels, and mounting attachment points as required for ease of use by the operator. The system 200 is shown in a rectangular enclosure 202 enclosing the system's batteries and in this example having a flip-open lid 204 allowing access to internal controls and circuitry. In this example, pairs of wheels 206a, 206b, 206c mounted on three of the four corners of the enclosure allow for easy loading and unloading of the system 200 into a transport vehicle and for moving the system along the ground or surface. In this exemplary embodiment, a multi-voltage portable power system as depicted in FIG. 1, is configured in another representative chassis design, having all the features and control functions as previously described, but housed in a different arrangement to complement the needs of the vehicles in which it can be mounted and operated by the user.

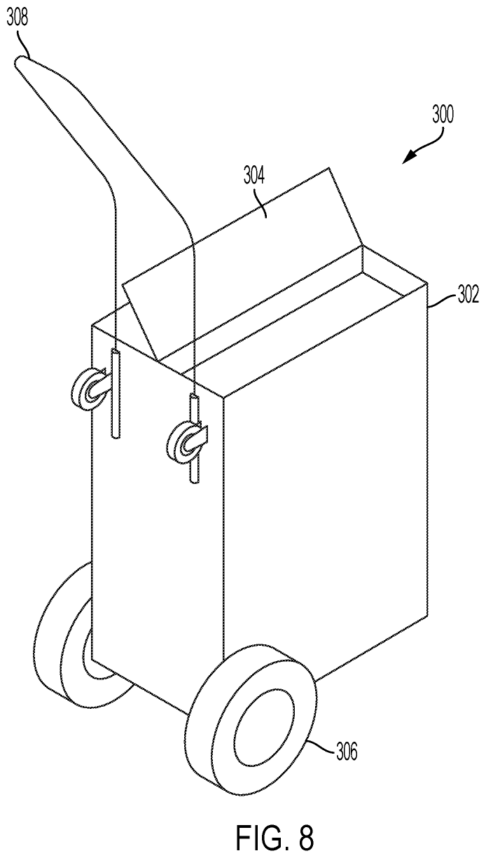

In a further exemplary embodiment as shown in FIG. 8, the multi-voltage portable power system 300 is deployed in a rolling enclosure. The system 300 includes a rectangular case 302 enclosing the system's batteries with an affixed removable panel and/or having a flip-open lid 304, allowing access to internal controls and circuitry. A pair of wheels 306 is positioned at one corner of the enclosure with a handle 308 extending upwardly to allow the system to be easily transported by a user.

In further embodiments, the present invention may be configured in a specific secondary power module configuration, with handles for transport and for ease of mounting to a host vehicle or for mechanical attachment to another multi-voltage portable power system. For example, the secondary power module may be configured so that it can be attached and/or adapted to mount to an existing multi-voltage portable power module for use and transport. The two modules can then be interconnected with electrical wiring to provide power and communication between the two power modules so that they can now be used in conjunction with one another, to supply parallel power for an additional time, whereas the unit is operating as additional reserve capacity for the primary battery system contained within the first power module configuration. Or the units may be operated and controlled and switched either mechanically or electronically as previously described by the operators command, so that the modules are re-configured into a series circuit arrangement, allowing the final output load of the modules to be the sum of the internal battery systems linked together in series, providing a higher voltage output as desired by the user, providing the appropriate output voltage for the load or for the vehicle requiring a higher voltage. A seventy two (72V) volt locomotive train could be jump started with a multitude of six power modules attached together electrically to provide twelve (12V) volts from six battery systems, resulting in a seventy two (72V) volt output that could then be used to attempt the jump start of seventy two (72V) volt powered locomotive trains. If the individual power modules are able to be switched or operated into a twenty four (24V) volt mode of operation, then three power modules of twenty four (24V) volt outputs could be interconnected together to create the desired seventy two (72V) volt final output for the load.

In this exemplary embodiment, individual power modules may be added or subtracted as needed to meet the required voltage output of the final user's application. And, internal components of the of the primary and secondary multi-voltage portable power module systems described may contain battery systems and control circuitry for configuring multiple battery systems within each module to a specific desired output.

Configured as singular battery system or multi-battery system, or by the addition of a secondary battery case power module which can be added as needed by the user and individually controlled by the operator or automatically by the system, to be in series or parallel circuit configuration for various outputs to meet the users need. These systems can be used as individual modules that can be added or subtracted from the main system as needed, enabling the user to add, for example, twelve (12V) volts, or twenty four (24V) volts or thirty six (36V) volts or more, in voltage capability to increase the overall voltage to the load. An example would be the need to increase the voltage to approximately seventy two (72V) volt DC which is normally required to jump start a locomotive train engine or other high-powered system. In this example, the higher voltage can be achieved by adding several system modules together or a singular unit can be designed to be fully self-contained that includes enough battery power systems to achieve the seventy two (72V) volts requirement on its own to meet the application need.

For example, in one exemplary embodiment, when the system is configured in the reverse mode, these individual battery cases could all be configured to match the electrical system of the host vehicle, and through control circuitry on the multi-voltage portable power system, all of these individual battery cases could be made to be charged by the host vehicle's electrical system. Portable individual multi-voltage portable power systems and/or individual portable battery cases, could be charged during transport while on mission and then, for example, when arriving at the forward operating base (FOB) of a military installation, the individual and independent multi-voltage portable power systems can be removed and taken into tents, command posts, or remote surveillance location and provide hours of silent power for the users. Additional individual portable battery cases can also be deployed with the multi-voltage portable power systems to add additional hours of reserve battery power to the user to extend the mission.

In further embodiments, the system may include sensing devices for complete automatic operation or manually operated by the user. Internal circuitry may include a microprocessor controller for control functions and features, including data logging and recording of operations and system's status, as well as remote wireless control and transponder communications. A battery management system (BMS) may be used on the battery systems themselves to properly charge and discharge the battery systems relative to their capability and type of battery chemistry used.

Preferably, the multi-voltage portable power system is mechanically contained in either a completely independent self-contained enclosure, which may also be used as a standalone device, or it can be made to be mechanically compatible with a chassis support structure, being described as an exterior chassis frame, that would accept the independent self-contained enclosure as a carrier rack for the self-contained multi-voltage portable power system. For any multi-voltage portable power system in accordance with the present invention that may be designed to interface with other multi-voltage portable power systems, or with reserve battery systems, the systems may be interfaced rudimentary as a basic system with just wires and connector interfaces between the units, or they may be smart systems that can communicate with one to the other or to a separate power load, such as an electric vehicle, using special connectors for the interconnection, but still electronically communicating prior to providing the correct and proper portable power to the load, to ensure system and user safety, with no electrical or electronic conflict with the load to be serviced.

Most preferably, the system of the present invention is compatible with solar, wind, hydro, mechanically generated, fuel generated and land based utility electrical power, allowing the battery systems to be recharged/replenished by whatever means available, including the operation of the host vehicle's engine and alternator system, or the engine and electric generator system of some other vehicle; (e.g., Lawn mower, motorcycle, tractor, aircraft, ATV, fuel powered generator, etc.). Further, the control mechanisms of the present invention can monitor and sense the total amount of voltage and amperage used or needed by the load and thus the battery systems that are interconnected can be made to be configured and controlled to provide the necessary voltage and amperage output from the system to meet the users' requirements by the addition of more batteries configured in parallel or more batteries configured in series to meet the performance parameters of the load to complete the task.

It is to be understood that the disclosed embodiments herein are merely exemplary of the invention, which may be embodied in various forms and enclosures. Therefore, specific structural and functional details disclosed herein are not to be interpreted as limiting, but merely as a basis for the claims and as a representative basis for the teaching one skilled in the art to variously employ the present invention in virtually any appropriate detailed structure.

From the above, it can be seen that the system and method of the present invention provides a multi-voltage portable power system that can be used to provide a desired nominal output voltage, and that further configuration of the system allows selection of one or more additional output voltages or amperage power levels, accomplished by logic to selectively interconnect the plurality of batteries or other energy storage devices to achieve the desired voltage and amperage output required specifically by the load.

While the system and method of the present invention have been described herein with respect to a switching mechanism, the switching mechanism itself may be simple in nature, or it may be very elaborate, enabling it to achieve the desired outcome power required by the user. The switching mechanism may be comprised of a linear actuator or other controllable device or devices, that when activated, performs its function, resulting in the activation or de-activation of a single or multiple conversion switches that are integrated into the circuitry, modifying the final power output of the system to the load connector. It should be understood that the system and method of the present invention may similarly be employed in conjunction with other system configurations and power sources, providing the desired power output required by the user. For example, the switching mechanism that activates an actuator of some type for this purpose may be electrically, hydraulically or pneumatically operated, or the actuator may be a rotary actuator configured to directly rotate the conversion switches into a desired position or to control an actuator into a desired position. In an electrically actuated system, voltage and current parameters may be sensed, monitored, actively controlled and even recorded to ensure the proper output during any operation of the system. Actuators using pressure parameters may be handled in similar fashion for the same purpose, however the final result of the operation of the system and method remains essentially unchanged.

With a proper understanding of how this multi-voltage portable power system invention can provide various outputs, meeting the load requirements of the user, it must then also be understood that if we view this invention in the reverse mode, it can easily be determined that the multi-voltage portable power system can then also be configured to match the specific voltage power system of any host vehicle, that it may be attached to, and can therefore remain in that specific voltage state to enable its internal system(s) to operate as normal and its batteries or other energy storage devices to be recharged by the host vehicle's electrical system. In the same manner as previously described, the matching of voltages for a particular host vehicle electrical system can be done manually or automatically via user interface or electronic sensing systems, switching the multi-voltage portable power system to the proper voltage mode to match the host vehicle's standard operating voltage. This will enable the system to be easily interfaced with a multiple of various host vehicles, which may each have their own specific operating voltage requirements, without any detrimental effects to either system; (e.g., Jump starting a locomotive train engine at 72 volts at its maximum amperage draw, or charging an electric vehicle at 375 volts at a specified level of amps, for charging the system as quickly as possible.)

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one that is skilled in the art and that can perform the particular function in a similar way. Certain features and sub-combinations are of utility and may be employed without reference to other features and sub-combinations and are contemplated within the scope of the claims.

What is claimed is:

1. A multi-voltage portable power system, comprising:
a plurality of energy storage devices;
a conversion switch; and
an output connector for attachment to a load; wherein the plurality of energy storage devices are in electrical communication with the conversion switch and the conversion switch is in further communication with the output connector, and wherein the conversion switch is operable to connect the plurality of energy storage devices in series, in parallel, and in combinations thereof to achieve a desired output voltage.

2. The multi-voltage portable power system of claim 1, further comprising a user-operated control switch in communication with the conversion switch, wherein the control switch actuates the conversion switch to a commanded configuration to achieve the desired output voltage.

3. The multi-voltage portable power system of claim 2, wherein the control switch comprises: hardwired connection, isolated connection, remote connection, or combinations thereof, to the conversion switch.

4. The multi-voltage portable power system of claim 3, further comprising a first sensor device to monitor the output voltage and provide an indication of the voltage to a user of the system.

5. The multi-voltage portable power system of claim 4, further comprising a second sensor device to monitor the voltage of an electrical system of a host vehicle transporting the system, wherein the monitored voltage of the host vehicle controls the conversion switch to achieve a matching output voltage.

6. The multi-voltage portable power system of claim 5, wherein the plurality of energy storage devices are charged by the host vehicle electrical system.

7. The multi-voltage portable power system of claim 6, wherein the plurality of energy storage devices are chargeable by solar panels, wind turbines, fuel-powered generators, power grid, and combinations thereof.

8. The multi-voltage portable power system of claim 1, wherein the plurality of energy storage devices, conversion switch, and output connector are housed in a portable enclosure.

9. The multi-voltage portable power system of claim 7, wherein the portable enclosure comprises, handles, wheels, and combinations thereof.

10. The multi-voltage portable power system of claim 1, wherein the plurality of energy storage devices, conversion switch, and output connector are housed in an enclosure configured to conform to a bed of a vehicle.

11. A multi-voltage portable power system, comprising:
a plurality of energy storage devices;
a conversion switch;
an output connector for attachment to a load; and
a microprocessor controller, wherein the plurality of energy storage devices are in electrical communication with the conversion switch and the conversion switch is in further communication with the output connector, wherein the conversion switch is operable to connect the plurality of energy storage devices in series, in parallel, and in combinations thereof to achieve a desired output voltage, and wherein the microprocessor controller is in communication with the plurality of energy storage devices and conversion switch to monitor and control system settings.

12. The multi-voltage portable power system of claim 11, further comprising a user-operated control switch in communication with the microprocessor and conversion switch, wherein the control switch provides a command signal to the microprocessor to actuate the conversion switch to a commanded configuration to achieve the desired output voltage.

13. The multi-voltage portable power system of claim 12, wherein the control switch comprises: hardwired connection, isolated connection, remote connection, or combinations thereof, to the conversion switch.

14. The multi-voltage portable power system of claim 13, further comprising a first sensor device in communication with the microprocessor to monitor the output voltage and amperage of the system and the electrical characteristics of the load to be connect to, and provide an indication of the voltage and amperage to a user of the system and to the system electronics to allow monitoring of the circuitry including monitoring each individual storage device to ensure proper electrical balancing of those devices.

15. The multi-voltage portable power system of claim 14, further comprising a second sensor device in communication with the microprocessor controller to monitor the voltage of an electrical system of a host vehicle transporting the system, wherein the monitored voltage of the host vehicle controls the conversion switch to achieve a matching output voltage.

16. The multi-voltage portable power system of claim 15, wherein the plurality of energy storage devices are charged by the host vehicle electrical system.

17. The multi-voltage portable power system of claim 16, wherein the plurality of energy storage devices are chargeable by solar panels, wind turbines, fuel-powered generators, power grid, and combinations thereof.

18. The multi-voltage portable power system of claim 11, wherein the plurality of energy storage devices, conversion switch, and output connector are housed in a portable enclosure.

19. The multi-voltage portable power system of claim 17, wherein the portable enclosure comprises, handles, wheels, and combinations thereof.

20. The multi-voltage portable power system of claim 11, wherein the plurality of energy storage devices, conversion switch, and output connector are housed in an enclosure configured to conform to a bed of a vehicle.
